(19) United States
(12) Patent Application Publication
(10) Pub. No.: US 2011/0242318 A1
(43) Pub. Date: Oct. 6, 2011

(54) SYSTEM AND METHOD FOR MONITORING BLIND SPOTS OF VEHICLES

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/824,207

(22) Filed: Jun. 27, 2010

(30) Foreign Application Priority Data
Mar. 31, 2010 (TW) 99110015

(51) Int. Cl. B60Q 1/00; H04N 7/18

(52) U.S. Cl. 348/148; 340/436; 348/E07.085

(57) ABSTRACT

A system for detecting blind spots of a vehicle while the vehicle is been driven includes an image capturing device of at least one side mirror, a warning device and a microprocessor. The image capturing device to capture images of the blind spots of the vehicle. Each of the captured images are analyzed to detect whether a moving object exists in the blind spot. A warning signal is generated in response to a detection of the moving object in the blind spots, and causing the warning device to alarm according to the warning signal.

### BACKGROUND

1. Technical Field

Embodiments of the present disclosure relate generally to monitor systems and methods, and more particularly to a system and method for monitoring blind spots of a vehicle.

2. Description of Related Art

Blind spots are areas of a road that cannot be seen while looking forward or through either the side or side mirrors during driving a vehicle. Vehicles in the adjacent lanes of the road may fall into these blind spots, and a driver may be unable to see them using only the mirrors. Unfortunately, a traffic emergency may happen if the driver cannot see what is in the blind spots. Blind spots can be eliminated by reducing overlap between side and side mirrors, or be checked by turning driver's head briefly, or by adding another mirror with a larger field of view.

### BRIEF DESCRIPTION OF THE DRAWINGS

FIG. 1 is a schematic diagram of one embodiment of a system for detecting blind spots of a vehicle.

FIG. 2 is a schematic diagram illustrating an image capturing unit of a side mirror installed on the vehicle.

FIG. 3 is a schematic diagram illustrating one example of a blind spot of the vehicle.

FIG. 4 is a schematic diagram illustrating another example of a blind spot of the vehicle.

FIG. 5 is a flowchart of one embodiment of a method for detecting blind spots of a vehicle using the system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

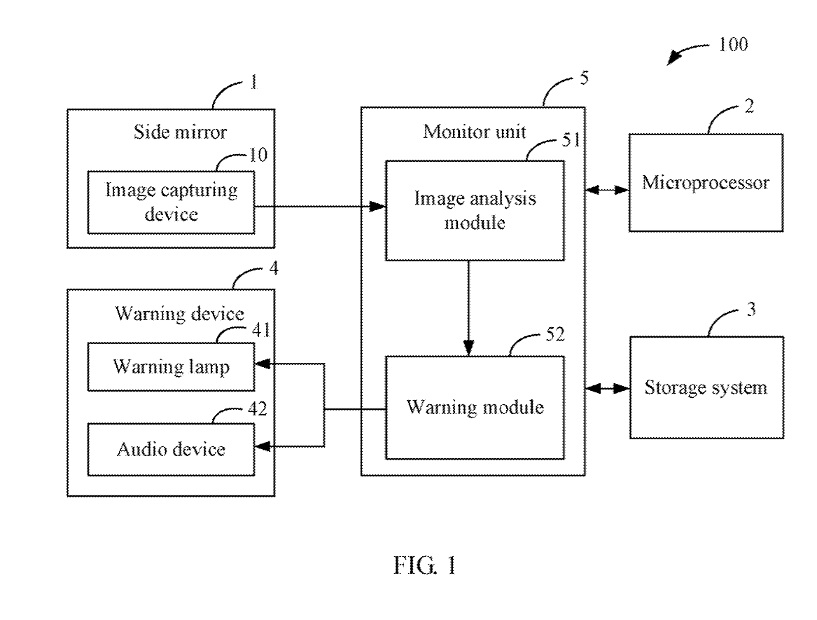

FIG. 1 is a schematic diagram of one embodiment of a system for monitoring blind spots (hereinafter “the monitor system 100”) of a vehicle. The monitor system 100 can be installed in the vehicle, such as a car, a truck, a bus, or any other ground vehicle. The monitor system 100 can detect the blind spots of the vehicle while the vehicle is driven. In one embodiment, the monitor system 100 includes an image capturing device 10 located on at least one side mirror 1 of the vehicle, a microprocessor 2, a storage system 3, a warning device 4, and a monitor unit 5. The components 1-5 may communicate with each other through electrical wires embedded in the vehicle. It should be apparent that FIG. 1 shows only one example of an architecture for the monitor system 100 and may include more or fewer components than shown, or a different configuration of the various components in other embodiments.

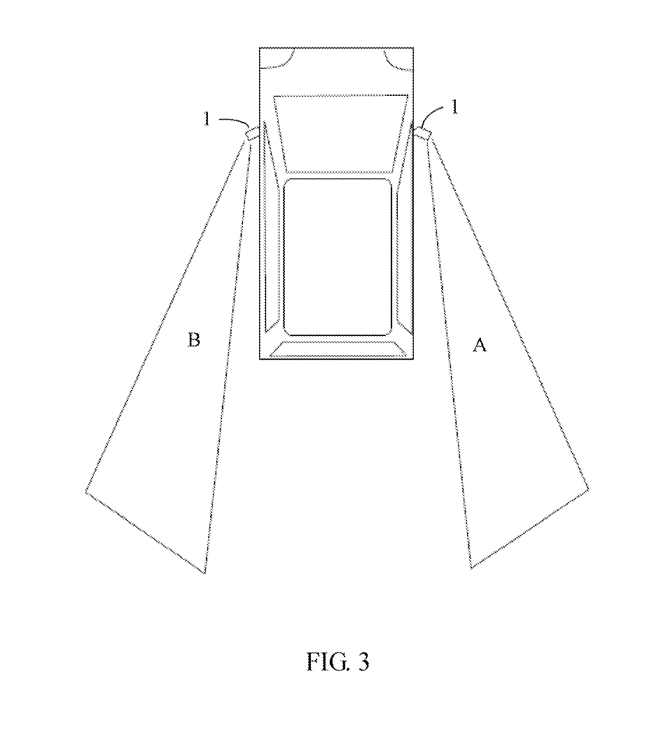

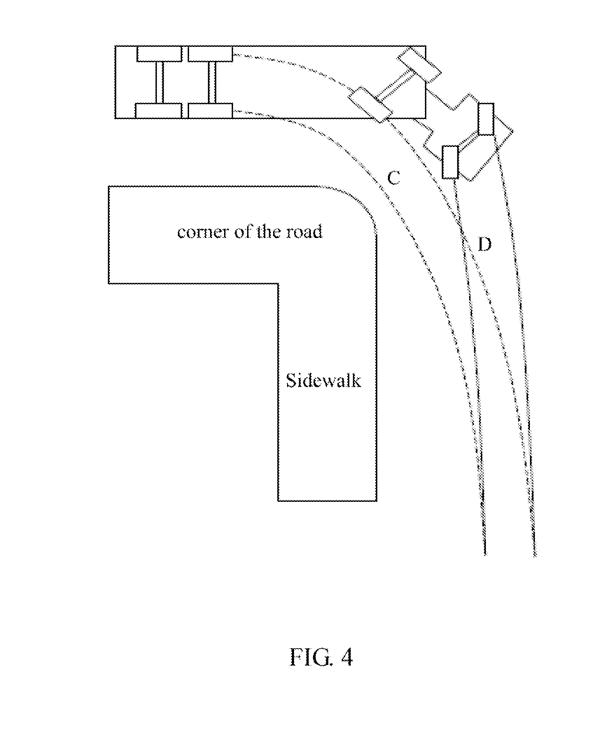

It should be understood that blind spots of a vehicle are typically in the rear and adjacent to both sides of the vehicle. Vehicles in adjacent lanes of a road may fall into these blind spots, and a driver may be unable to see them using only mirrors on the vehicle. Other blind spots are those areas low at the back and at the front of the vehicle. Also, in cases where side vision is hindered, areas to the left or right can become blind spots as well. In order to illustrate the blind spots, two exemplary embodiments are shown in FIG. 3 and FIG. 4. Referring to FIG. 3, the blind spots, such as an area “A” and an area “B”, may exist because of the size and the orientation of the side mirror 1. Referring to FIG. 4, the blind spots, such as an area “C” and an area “D”, may exist because of the driving track when the vehicle turns a corner of the road.

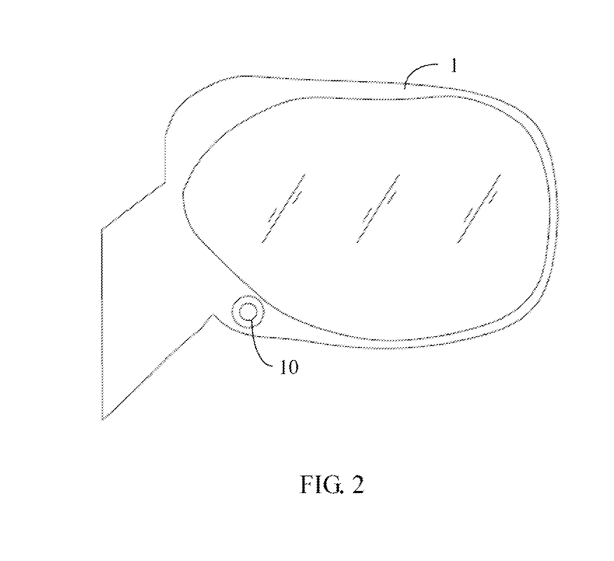

In some embodiments, the at least one side mirror 1 are located on two sides of the vehicle, for example, two side mirrors 1 are shown in FIG. 3. Each of the side mirror 1 includes an image capturing device 10 installed on the side mirror 1, as shown in FIG. 2, for example. In one embodiment, the image capturing device 10 may be a video camera, or a digital camera, for example. The image capturing device 10 is operable to capture images of the blind spots of the vehicle while the vehicle being driven, and sends the captured images to the microprocessor 2 to check whether a moving object exists in the blind spots. The moving object may be an object, a person, an animal, or other vehicles, for example.

The microprocessor 2 runs software modules stored in the storage system 3 to monitor the blind spots when the vehicle is being driven. In one embodiment, the storage system 3 may be an internal storage device, such as a random access memory (RAM) for temporary storage of information and/or a read only memory (ROM) for permanent storage of information. In other embodiments, the storage system 3 may also be an external storage device, such as a hard disk, a storage card, or a data storage medium.

In one embodiment, the warning device 4 includes a warning lamp 41 and an audio device 42. Upon detecting the moving object exists in a blind spot, the warning lamp 41 may be set to flash, and/or the audio device 42 is set to make a warning sound to alert the driver. In other embodiments, the warning device 4 may further include a display device to display the image of the blind spot, so that the driver may be aware of the moving object existing in the blind spot.

In one embodiment, the monitor unit 5 includes an image analysis module 51 and a warning module 52. One or more computerized codes of the function modules 51-52 may be stored in the storage system 3 and executed by the microprocessor 2. In general, the word “module,” as used herein, refers to logic embodied in hardware or firmware, or to a collection of software instructions, written in a programming language. The software instructions in the modules may be embedded in firmware, such as an EPROM. The modules described herein may be implemented as either software and/or hardware modules and may be stored in any type of computer-readable medium or other storage device.

The image analysis module 51 is operable to control the image capturing device 10 to capture images of the blind spots of the vehicle, and to receive the captured images from the image capturing device 10. The image analysis module 51 is further operable to analyze each of the captured images using an object movement detection method, and to detect whether the moving object exists in the blind spots according to the analysis result.

After the images of the blind spots is captured by the image capturing device 10, the image analysis module 51 analyzes a movement state of the object by using the movement detection method. The movement state may include information, such as, a direction and a speed of the moving object. In one embodiment, the object movement detection method can be described as follows: recording pixel values in each image, comparing pixel values in current image with pixel values in previous image, detecting a direction and a speed of the moving object according to the comparison result, and determining whether the moving object exists in the blind spot according to the direction and speed of the moving object.

The warning module 52 is operable to generate a warning signal when a moving object is detected in the blind spots. In some embodiment, in response to a generation of the warning signal, the warning module 52 controls the warning lamp 41 to flash, and/or the audio device 42 to generate a warning sound to alert the driver.

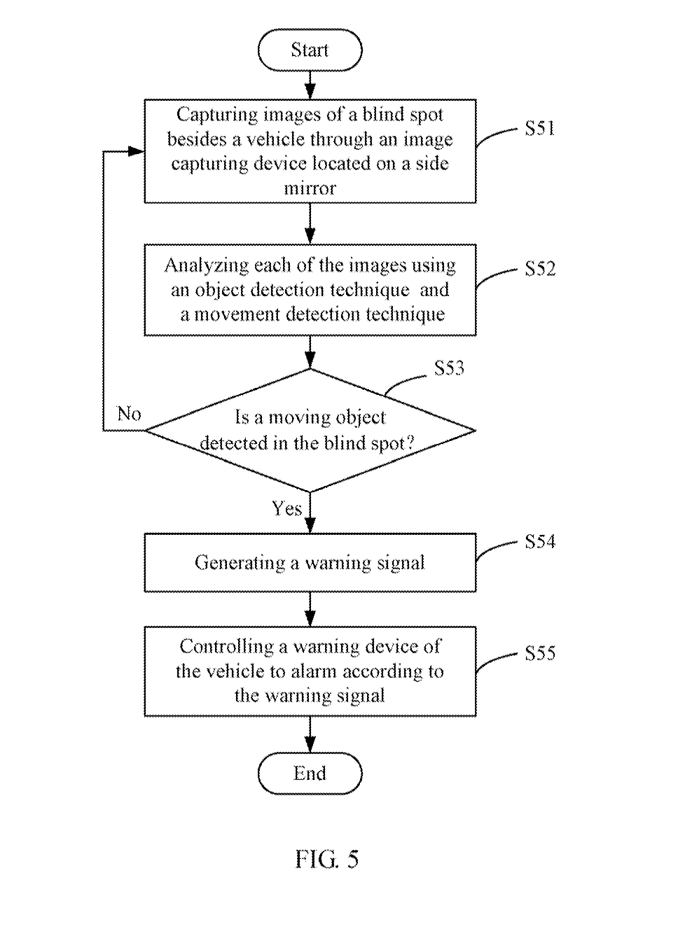

FIG. 5 is a flowchart of one embodiment of a method for monitoring blind spots of a vehicle using a system such as, for example, that of FIG. 1. The method can detect the blind spots of the vehicle by the at least one side mirror 1 while the vehicle is driven. Depending on the embodiment, additional blocks may be added, others removed, and the ordering of the blocks may be changed.

In block S51, the image analysis module 51 controls the image capturing device 10 to capture images of blind spots of the vehicle. In one embodiment, the image capturing device 10 is installed on the at least one side mirror 1, as shown in FIG. 2, for example. The blind spots may exist because of the size and the orientation of the side mirror 1 on the vehicle, and/or a driving track of the vehicle. For example, an area “A” and an area “B” are shown in FIG. 3, and an area “C” and an area “D” are shown in FIG. 4.

In block S52, the image analysis module 51 analyzes each of the captured images an object movement detection method. As mentioned above, the object movement detection method includes recording pixel values in each of the captured images, comparing pixel values in a current image with pixel values in a previous image, detecting a direction and speed of the moving object according to the comparison result; and determining whether the moving object exists in the blind spots according to the direction and speed of the moving object.

In block S53, the image analysis module 51 detects whether a moving object exists in the blinds spot according to the analysis result. If no moving object is detected in the blind spots, block S51 is repeated. Otherwise, if the moving object is detected in the blind spots, block S54 is implemented.

In block S54, the warning module 52 generates a warning signal to the warning lamp 41 and the audio device 42. In block S55, the warning module 52 controls the warning device 4 to alarm according to the warning signal. For example, the warning lamp 41 may flashes and/or the audio device 42 may generate the warning sound to alert the driver.

In other embodiments, the warning device 4 may further include a display device to display the images captured by the image capturing device 10. Upon detecting the moving object exists in the blind spots, the display device displays the images to the driver, so that the driver may be aware of the moving object existing in the blind spots by viewing the captured images.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A system for monitoring blind spots of a vehicle, the system comprising:
an image capturing device located on at least one side mirror of the vehicle;
a storage system, and a microprocessor;
a monitor unit stored in the storage system and being executable by the microprocessor, the a monitor unit comprising:
an image analysis module operable to control the image capturing device to capture images of a blind spot of the vehicle, to receive the captured images from the capturing device, and to analyze the captured images to detect whether a moving object exists in the blind spot; and
a warning module operable to generate a warning signal in response to a detection of the moving object in the blind spot, and to control a warning device to alarm according to the warning signal.

2. The system according to claim 1, wherein the warning device comprises a warning lamp operable to flash according to the warning signal.

3. The system according to claim 1, wherein the warning device comprises an audio device for generating an alarm sound according to the warning signal.

4. The system according to claim 1, wherein the warning device comprises a display device for displaying the captured images sent from the capturing device.

5. The system according to claim 1, wherein the image analysis module analyzes the captured images by recording pixel values of each of the captured images, comparing each of the pixel values in a current image with the pixel value in a previous image, detecting a direction and a speed of the moving object according to the comparison result, and determining whether the moving object exists in the blind spot according to the direction and speed of the moving object.

6. A method for detecting blind spots of a vehicle, the vehicle comprising at least one side mirror, the method comprising:
controlling an image capturing device of the at least one side mirror to capture images of the blind spots of the vehicle;
analyzing the captured images to detect whether a moving object exists in the blind spot;
generating a warning signal in response to a detection of the moving object in the blind spot; and
controlling a warning device of the vehicle to alarm according to the warning signal.

7. The method according to claim 6, further comprising:
displaying the captured images on a display device of the vehicle in response to a detection of the moving object in the blind spot.

8. The method according to claim 6, wherein the step of controlling a warning device comprises:
controlling a warning lamp of the vehicle to flash according to the warning signal.

9. The method according to claim 6, wherein the step of controlling a warning device comprises:
controlling an audio device of the vehicle to generate an alarm sound according to the warning signal.

10. The method according to claim 6, wherein the step of analyzing the captured images comprises:
recording pixel values of each of the images;
comparing each of the pixel values in a current image with the pixel value in a previous image;
detecting a direction and a speed of the moving object in response to the comparison; and
determining whether the moving object exists in the blind spot according to the direction and the speed of the moving object.

11. A storage medium having stored thereon instructions that, when executed by a microprocessor of a vehicle comprising at least one side mirror, causes the vehicle to perform a method for detecting blind spots of the vehicle, the method comprising:
controlling an image capturing device of the at least one side mirror to capture images of the blind spots of the vehicle;
analyzing the captured images to detect whether a moving object exists in the blind spot;
generating a warning signal in response to a detection of the moving object in the blind spot; and
controlling a warning device of the vehicle to alarm according to the warning signal.

12. The storage medium according to claim 11, wherein the method further comprises:
displaying the captured images on a display device of the vehicle in response to a detection of the moving object in the blind spot.

13. The storage medium according to claim 11, wherein the step of controlling a warning device comprises:
controlling a warning lamp of the vehicle to flash according to the warning signal.

14. The storage medium according to claim 11, wherein the step of controlling a warning device comprises:
controlling an audio device of the vehicle to generate an alarm sound according to the warning signal.

15. The storage medium according to claim 11, wherein the step of analyzing the captured images comprises:
recording pixel values of each of the images;
comparing each of the pixel values in a current image with the pixel value in a previous image;
detecting a direction and a speed of the moving object in response to the comparison; and
determining whether the moving object exists in the blind spot according to the direction and the speed of the moving object.
